(19) United States
(12) Patent Application Publication
(10) Pub. No.: US 2014/0140164 A1
(43) Pub. Date: May 22, 2014

(54) Homogeneity Sensor For Product Blender/Mixer

(71) Applicants: David G. Greer, Cambridge, MN (US); Joshua D. Braun, Mounds View, MN (US); Joel R. Gulbranson, Ham Lake, MN (US)

(72) Inventors: David G. Greer, Cambridge, MN (US); Joshua D. Braun, Mounds View, MN (US); Joel R. Gulbranson, Ham Lake, MN (US)

(73) Assignee: Agrichem, Inc., Ham Lake, MN (US)

(21) Appl. No.: 14/064,281

(22) Filed: Oct. 28, 2013

Related U.S. Application Data
(60) Provisional application No. 61/728,332, filed on Nov. 20, 2012.

(51) Int. Cl. B01F 15/00

(52) U.S. Cl. CPC B01F 15/00227
USPC 366/142

(57) ABSTRACT

A method and apparatus for monitoring the degree of blending of the constituents of a mixture being churned in a blender involves placement of a dielectric properties sensor in a wall of the blender. In that such sensors respond to moisture content, density and temperature of the ingredients, when the sensor output reaches a steady-state, it is indicative of arrival of a homogenous mix.

### CROSS REFERENCE TO RELATED APPLICATION

This application claims priority from U.S. provisional application Ser. No. 61/728,332, filed Nov. 20, 2012, entitled “Homogeneity Sensor For Product Blender/Mixer”, the contents of which are hereby incorporated in their entirety by reference.

### BACKGROUND OF THE INVENTION

1. Field of the Invention

This invention relates generally to systems for mixing: 1) dry particulate or powdered ingredients or 2) mixing liquids with dry particulate or powdered ingredients or non-aqueous liquids and more particularly to such systems incorporating a sensing mechanism for detecting and indicating the degree to which a mixture has become homogenous.

2. Discussion of the Prior Art

Mixing or blending of multiple ingredients is a fundamental part of many manufacturing processes including, but not limited to, animal feed manufacturing, food manufacturing, fertilizer production, pharmaceutical manufacturing, etc.

A coefficient of variance (CV) is the standard measure of mixing completeness, A CV is determined empirically by sampling the mixture after a prescribed mixing time at a number of sites in the mixer, performing a laboratory assay on each sample for a specific component in the mixture and statistically analyzing the data generated. This typically requires samples be brought to a laboratory for analysis. Because of the time lapse and expense associated therewith, real-time process control is not possible.

Performing a CV analysis and assuming it to be constant for a particular mixer is commonly done, but this approach has at least two problems associated with such an assumption, First of all, a CV for one mixture does not necessarily apply to any other mixture because of differences in the physical characteristics of the ingredients Secondly, the coefficient of variance is subject to change due to wear as the mixer ages.

A need therefore exists for an on-line, real-time monitoring device for a mixer that continuously provides an output signal that automatically adapts to the physical characteristics of the components and/or the age of the mixer.

In a research article entitled “Monitoring Powder Blend Homogeneity Using Light-Induced Fluorescence” by Karumarichi et al. and published in AAPS PharmSciTech, Vol. 12, No. 4, December 2011, there is described a method in which light-induced fluorescence is used as a tool to assess blend homogeneity as a function of time for commercial products as a substitute for high pressure liquid chromatography. Again, the equipment required in terms of cost and the skill required for interpretation is too significant to render this approach practical in a commercial sense.

It is a accordingly a principal object of the present invention to provide a low-cost, rugged, yet accurate sensor for use in a mixing vessel for determining when an acceptable state of homogeneity of components being mixed has been reached.

### SUMMARY OF THE INVENTION

In accordance with the present invention, there is incorporated into the wall of a mixing vessel a dielectric properties sensor that responds primarily to moisture content, density and temperature of the ingredients being mixed. As mixing occurs, the dielectric properties of the individual ingredients merge, producing a distinct new set of dielectric properties belonging to the homogenized mixture. The dielectric properties sensor generates a signal reflecting this change. The sensor itself may be of a type described in our earlier U.S. Pat. No. 6,249,130 B1 and in U.S. Pat. No. 6,388,453 B1.

### DESCRIPTION OF THE DRAWINGS

The foregoing features, objects, advantages of the invention will become apparent to those skilled in the art from the following detailed description of a preferred embodiment, especially when considered in conjunction with the accompanying drawings in which like numerals in the several views refer to corresponding parts.

FIG. 1(a) is a partial, sectioned, side-view schematic drawing of a commercial industrial blender with which the homogeneity sensor of the present invention finds use.

FIG. 1(b) is a schematic end-view drawing showing a dielectric properties sensor mounted in the wall of a mixer like that of FIG. 1.

FIG. 2 is a schematic drawing illustrating the manner in which the dielectric sensor is mounted on a mixer.

FIG. 3 is a plan view of the sensor module.

FIG. 4 is a cross-sectional view taken along the lines 4-4 in FIG. 3 and with associated drive and output circuitry connected to the sensor module.

FIG. 5 is a plot of the output signal from the sensor module as water was added to ground corn sequentially in five separate steps.

### DESCRIPTION OF THE PREFERRED EMBODIMENT

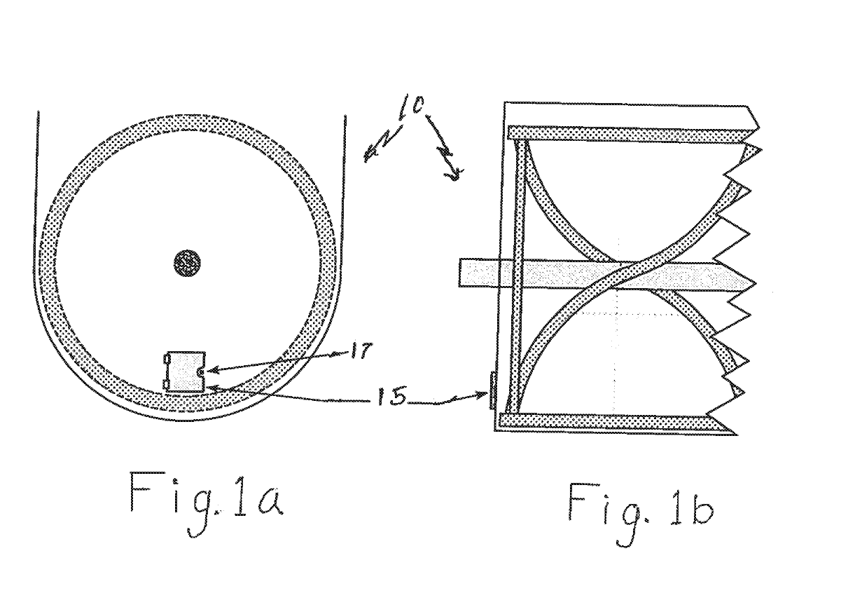

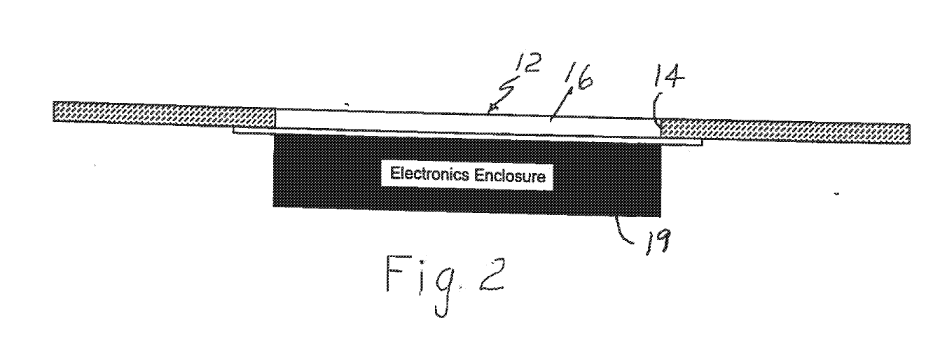

Referring to FIGS. 1a, 1b and 2 there is illustrated schematically an industrial mixer indicated generally by numeral 10. These are not intended to suggest any particular type of mixer because the type is not important to the function of this invention. It could be a ribbon blender, a paddle mixer, a rotating drum mixer, a vertical mixer or a horizontal mixer, etc. The only requirement is that the sensor be mounted in the mixer in a manner that allows it to make consistent, physical contact with a representative sample of the materials being mixed.

After a period of time, the several materials placed in the mixer become uniformly distributed throughout the mixture and the homogenized product is typically discharged from the mixer or additional ingredients may be added, depending on the process involved.

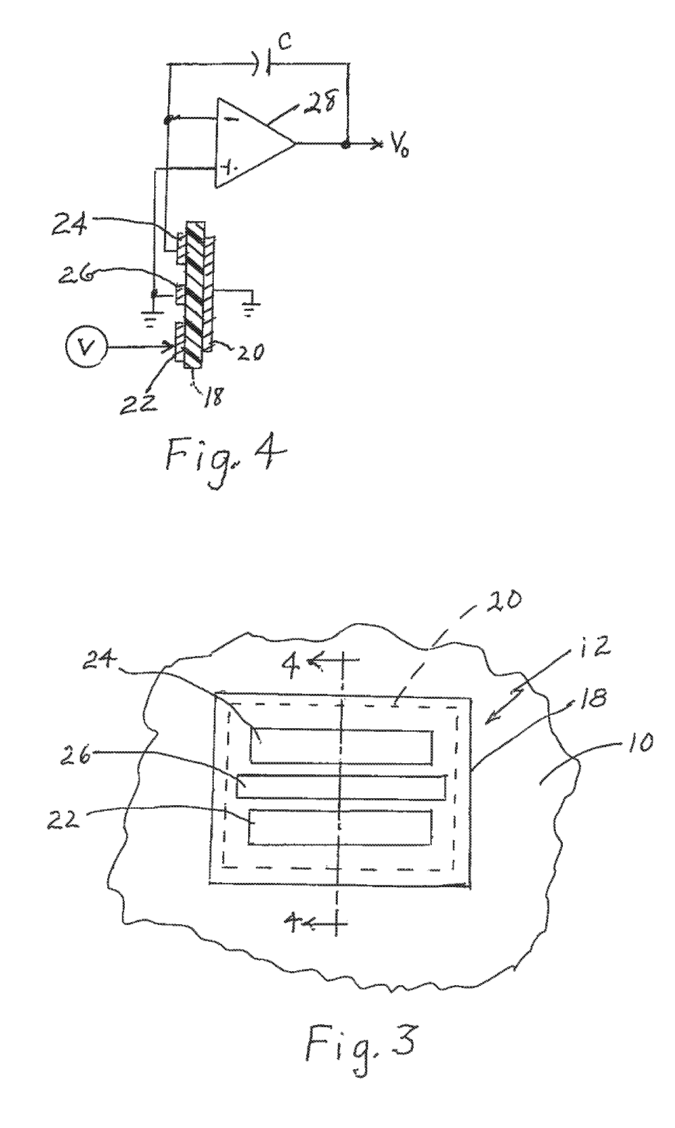

In accordance with the present invention, a sensor module 12 (FIG. 2) is mounted over an aperture 14 formed through the sidewall or end of the mixer tank 10. The sensor is shown as being mounted on the tank behind a mounting door 15 secured by a bolt latch 17 such that the sensor face is flush with the interior wall of the tank. FIG. 1 shows how the sensor module 12 is mounted within a hinged door frame. This mode of mounting allows easy access to the sensor for cleaning, repairing or replacement. The sensor face is preferably protected from abrasion by a ceramic plate 16 (FIG. 3). The electronic components for the sensor may be contained in a protective housing 19 on the exterior surface of the mixer tank 10.

Referring to FIG. 3, there is shown a plan view of the sensor module 12 as seen from the interior of the mixer tank 10. It is seen to comprise an insulating substrate 18 having a conductive shield electrode 20 on the obverse side of the substrate and a pair of conductive electrodes 22 and 24 in the form of rectangular strips in parallel, spaced-apart relation on the face of the substrate 18. Disposed between the parallel strip electrodes 22 and 24 is a further shield electrode 26.

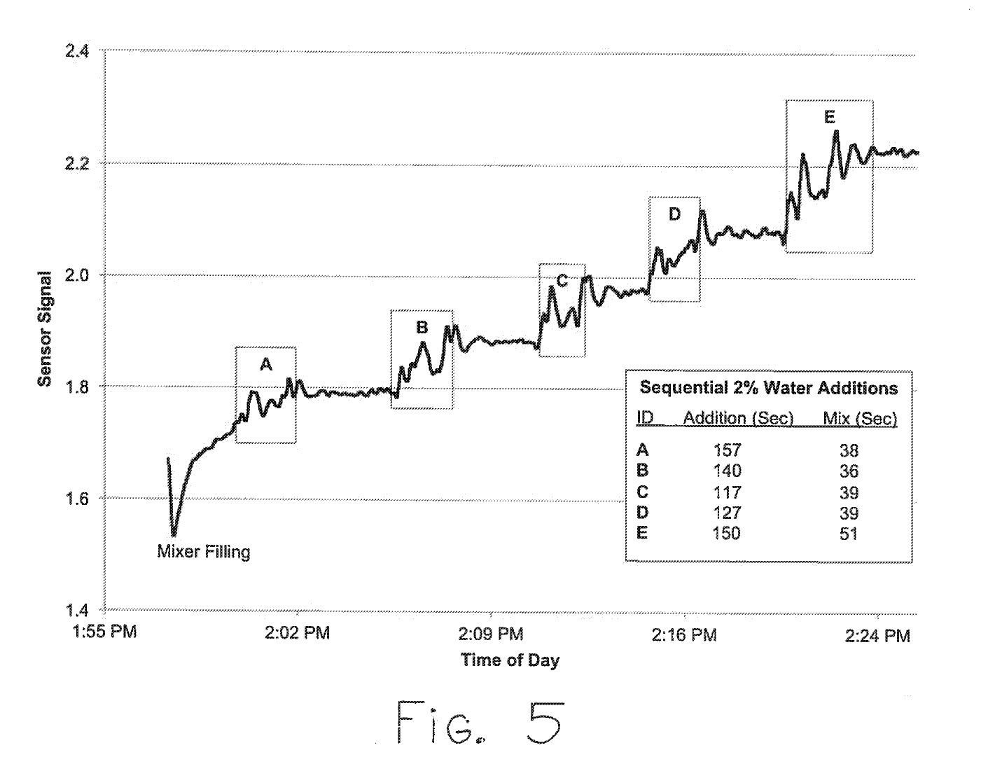

The sensor module 12 is more fully described in the Greer Patent U.S. Pat. No. 6,249,130 B1, the contents of which are hereby incorporated by reference. As is explained in that patent, when the shield electrodes 18 and 26 are connected to ground and a voltage is applied to one of the strip electrodes 22 or 24, an electric field is produced that projects out from the face of the sensor module 12 into the interior of the tank 10. The sensor 12 responds primarily to moisture content, density and temperature of the material being mixed. Initially the sensor “sees” the individual components passing over its surface and responds to the distinct dielectric properties of each. As mixing occurs, individual ingredients become uniformly distributed throughout the mixture, their dielectric properties merge and a new set of dielectric properties unique to the mixture emerges. The dielectric property sensor 12 generates a signal reflecting this change. Referring to FIG. 5, there is shown an actual record of a dielectric properties sensor mounted in the wall of a mixer and monitoring water addition to ground corn. Five separate 2% additions were made sequentially and the sensors response to these additions is indicated by the boxes A, B, C, D and E. The response is clearly a stair-step pattern. The sensor responds to the added water as it passes more or less intact over the sensor surface before it is blended into the corn, at which time the signal returns to a steady state at the higher moisture content. Varying the addition rates of the water does not affect this basic pattern however, as the moisture content of the mixture increases, the sensor response to the added water also increases. An analog slope detector or a microprocessor chip may be used to produce a control signal for alerting an operator, stopping the mixer, discharging the completed mixture or initiating a different process step when the sensor signal remains relatively constant for a predetermined time period.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself. For example, there may be other sensor geometries that may also be able to respond to mixing, but it has been applicant's experience that the flat plate version described herein has proven superior.

What is claimed is:

1. Apparatus for determining the extent of homogeneity in a batch of bulk ingredients being mixed comprising:
(a) a mixing vessel having a blending mechanism contained therein; and
(b) a dielectric properties sensor integrated onto a wall of the vessel.

2. The apparatus of claim 1 wherein the dielectric properties sensor is generally planar and has a face surface thereof mounted flush with an interior wall of the vessel.

3. The apparatus of claim 1 wherein the dielectric properties sensor is responsive to at least one of the following: moisture content, density and temperature of the ingredients being mixed.

4. The apparatus as in claim 3 wherein the dielectric properties sensor generates a control signal that can initiate a change in operation of the mixing vessel.

5. The apparatus as in claim 4 wherein the control signal is produced when an output signal from the dielectric properties sensor remains generally constant over a predefined time interval.

6. A method of monitoring the homogeneity of a mixture of ingredients being blended comprising the steps of:
(a) providing a mixing vessel having a blending mechanism contained therein for churning the ingredients;
(b) flush-mounting a shielded, flat-plate, dielectric properties sensor to an interior wall of the mixing vessel; and
(c) monitoring an output signal from the dielectric properties sensor as the ingredients are being mixed to detect when the output signal remains generally constant for a predefined time interval.
